(19) United States
(12) Patent Application Publication
(10) Pub. No.: US 2018/0026876 A1
(43) Pub. Date: Jan. 25, 2018

(54) Method for Transferring Application Specific Packets

(71) Applicant: Siemens Aktiengesellschaft, Muenchen (DE)

(72) Inventor: Guenter Steindl, Poppenricht (DE)

(73) Assignee: SIEMENS AKTIENGESELLSCHAFT

(21) Appl. No.: 15/654,034

(22) Filed: Jul. 19, 2017

(30) Foreign Application Priority Data
Jul. 22, 2016 (EP) 16180793.8

(51) Int. Cl. H04L 12/725; H04L 12/707; H04L 12/721; H04L 29/06

(52) U.S. Cl. CPC H04L 45/306; H04L 69/22; H04L 45/22; H04L 45/70; H04L 69/329

(57) ABSTRACT

A method for transferring application-specific packets in a network of an industrial automation system, wherein virtual networks can be set up in the network where the application-specific packets are classified into at least one of isochronic classes, real-time classes and basic classes, at least one virtual network (VLAN) with one network identifier per class is provided, and where the application-specific packets is transmitted over the virtual network selected according to its class, together with the corresponding network identifier such that the functions of application-specific protocols are enabled to be efficiently made available on new generations of standard hardware while retaining customary functionality.

### BACKGROUND OF THE INVENTION

### 1. Field of the Invention

The invention relates to a communication device, a terminal and a method for transferring application-specific packets in a network, where it is possible for virtual networks to be set up in the network.

### 2. Description of the Related Art

Methods for transferring application-specific packets, together with the associated terminals and switches, are employed in industrial automation, for example. In such cases, application-specific packets can be PROFINET packets, for example, and the network can be an Ethernet-based network, for example. The packets in layer 2 of the OSI layer model are also often described as frames. It should also be possible to set up virtual networks in the network. Virtual networks transmit packets over a network, mainly in layer 2 and based on an address, in particular based on the MAC address of the sending device and the receiving device. These virtual networks offer the possibility to span several networks without expensive network hardware, to also assign individual users to several networks and in turn supply these networks to several uses. Recent standards in the area of virtual networks now make it possible to send even time-critical, or TSN packets over standard LANs (e.g., over Ethernet), including while retaining the usual determinism of application-specific protocols. Virtual networks are standardized in, among other places, IEEE 802.1Q. In order to meet the high requirements of application-specific protocols for transmitting application-specific packets with standard hardware, it has until now normally been necessary to change the architecture of this standard hardware and therefore to lose at least some standard functionalities. With the new generation of hardware, it is now possible to transmit application-specific packets over networks, even with standard hardware.

### SUMMARY OF THE INVENTION

It is an object of the invention to provide a method that efficiently enables the functions of application-specific protocols to be made available on new generations of standard hardware while retaining customary functionality.

This and other objects and advantages are achieved in accordance with the invention by a method for transferring application-specific packets in a network of an industrial automation system where, it is possible for virtual networks to be set up in the network. In accordance with the invention, the method comprises classifying the application-specific packets into at least isochronic classes, real-time classes and basic classes, providing at least one virtual network with one network identifier per class, and transmitting the application-specific packets over the virtual network selected according to its class, together with the corresponding network identifier.

In such cases, the classification of the application-specific packets can be achieved using any devices of which the communications equipment provided is for the classification of application-specific packets. This can, for example, be devices of which the packets are appropriately classified by themselves or their communications interfaces. Even devices that do not possess such a function can participate in application-specific and classified communication, by being connected to a port or an interface that in turn implements the classification for the terminals. Ports of this kind can be provided by switches or bridges, for example.

The provision of a virtual network can, depending on its configuration, be implemented on various terminals. In such cases, the configuration of the virtual network can, for example, be performed by the terminals themselves, by a central unit or by a higher level central instance. It is, for example, possible for engineering software to already be configuring the necessary virtual networks automatically, or according to specifiable rules, and distributing them accordingly among the devices in the network. In this case the classes define the communication requirements that are to be met by means of the application-specific packets.

In such cases, it is normally the basic class that is used for the transmission of engineering and other data of which the transmission is not time-critical.

With the real-time class, it is possible for cyclical data to be transmitted, as is known from field buses and is realized with PROFIBUS or PROFINET. The real-time class is particularly provided for communication between controllers and sensors and actors, especially if the sensors and actors are not, such as for structural reasons, for direct connection with the local controllers, and communication over a BUS or a network is necessary. Acyclical data transmitting in the real-time class is also possible via read and/or write services. Diagnostic information and log book entries would be examples to name, here.

With the isochronic class, clock-synchronous transmission of data with a high clock rate and high jitter precision is possible. This is particularly required with motion control applications. A distinction can be made between the individual classes here based on their clock rate and their jitter precision.

Finally, the application-specific packets are transmitted over the virtual network selected according to their class, together with the corresponding network identifier. This ensures that the application-specific packets are transmitted with the right priority over the virtual network.

In a further embodiment, the network is an Ethernet-based network. This is advantageous, as in this way standardized hardware and controllers can be used, thus allowing considerable cost savings to be made.

In a further particularly advantageous embodiment, an initialization packet that is not assigned to any of the isochronic classes or real-time classes is transmitted over a virtual network to initialize an application-specific connection of one of the isochronic classes and/or real-time classes. In this way, it is possible to maintain “fast startup” features. For example, a “Hello” packet of a new terminal is sent over a non-classified virtual network to allow a configuration for communication to then be performed directly over the classified networks. It is also conceivable, either alternatively or redundantly, for such an initialization packet to be transmitted over the basic class and/or over a non-classified network.

In a further particularly advantageous embodiment, an initialization packet is transmitted over another virtual network to initialize an application-specific connection of one of the isochronic classes and/or real-time classes. The other virtual network exists in addition to the virtual networks of the application-specific classes. It can thus be a non-classified virtual network that is provided for the transmission of non application-specific packets. Any data can be transmitted in this way that can be transmitted over traditional networks, such as “best effort traffic”. Furthermore, another virtual network can be provided for the transmission of initialization packets and/or application-independent packets. This further virtual network can, however, make connections that are created outside the classified virtual networks available between all users of the network. For example, terminals could be configured such that they only allow classified connections and, additionally, initialization packets, over other virtual networks. All other packets could then be rejected, such as for security reasons.

It is particularly advantageous if at least one filter identifier is assigned to each of the virtual networks of the isochronic class and the real-time class. A filter identifier (FID), also called a “filtering database identifier” (FDB ID), is assigned to each virtual network of the named classes. The filter identifier assigns a filter database (FDB) in which the usable topology is stored to the virtual network. In this way, physical components with real ports and physical connections are assigned to the virtual networks. Each of the isochronic classes and the real-time class has a filter identifier assigned to it. As a result, it is possible for each of the classes to reserve its own resources. This makes even more improved provision of the application-specific functions possible.

In a further advantageous embodiment, a redundant virtual network with a network identifier is provided for each virtual network of the isochronic class and/or the real-time class. The provision of redundant virtual networks for the isochronic class and/or the real-time class achieves greater transmission certainty for application-specific packets as a result of the redundancy. Physical resources can also be reserved for the redundant transmission. It is also possible to assign a filter identifier to the redundant virtual networks.

In a further embodiment, each redundant virtual network of the isochronic class and/or of the real-time class is assigned a filter identifier. In this way, optimal transmission of redundant packets having the topology assigned to the filter identifiers is also possible. It is possible for each classified virtual network and its redundant virtual networks to have its own filter identifier and its own network identifier. In this way, maximum control over packet traffic, or the transfer of packets, is possible.

In a particularly advantageous embodiment, configuration of the virtual network of at least one device that is using the network is performed by a higher level instance. The higher level instance can, for example, be engineering software in which an automation system and its network and communications connections are planned and configured. The higher level instance can then, automatically or via further pre-specifiable configuration steps, implement the necessary set up of the virtual network on the devices in the network. In such cases it is also conceivable only to set up a central switch or a terminal, which in turn passes on its configuration to further devices.

Furthermore, the following additions can be combined with the invention and fall within the inventive concept. The TSN domain is protected on the boundary port by priority remapping. That means that if required, all packets are inspected and provided with a new TCI.PCP value, or tagged. There is a possibility of setting up an automatic boundary by MSRP or LLDP. With the aid of the peer-to-peer protocols MSRP or LLDP neighbors can exchange their TSN domain IDs. Where domains are the same, there is no boundary but where domains differ there is a boundary. FDB to VLAN assignment can occur via an FID. The FDB instance can therefore be identified via the FID (FDB ID). A tree, i.e., a usable topology, is assigned to an FID.

Virtual local area networks (VLAN) must be set up. At the same time, it is ascertained whether the VID of a VLAN has been assigned its own FID. The FID is the connection between the VIDs. If there are several VIDs on the VLAN, then the FID is the parenthesis. A topology (also called a tree) is in turn assigned to an FID. If no loop prevention is used in an FID then all ports remain available to this VLAN topology.

Assignment of resources is often manufacturer-specific, with guaranteed resources mostly being assigned by queue, and an additional global pool being available in case the guaranteed resources are exhausted.

In a network in which packets are sent that cannot be assigned to either PROFINET or TSN communication, this is performed over another virtual network (also called the default VLAN). The default VLAN is therefore not classified.

It is also an object of the invention to provide a communications device for execution of the method in accordance with disclosed embodiments of the invention. The communications device has at least one communications control unit and a plurality of interfaces, with the communications control unit for the classification of application-specific packets being formed in at least isochronic classes, real-time classes and/or basic classes, as well as for sending and/or receiving application-specific packets over a virtual network. Here, the communications device can be a switch or a bridge for industrial communication via an application-specific protocol. It is conceivable that future standard switches and bridges will also be able to achieve application-specific communication using the method in accordance with disclosed embodiments of the invention.

It is also an object of the invention to provide a terminal for communication via the method in accordance with disclosed embodiments of the invention that has at least one port and at least one communications interface. Here, the communications interface is configured to classify application-specific packets in at least isochronic classes, real-time classes and/or basic classes, as well as to send or receive application-specific packets over a virtual network. The communications interface can, for example, be an Application Specific Integrated Circuit (ASIC) that classifies the packets, provides them with an appropriate VLAN tag and sends them. In the future, it will be possible to use Ethernet chips of the respective latest generation. The terminal here can be either a control system or motors, converters, sensors and other actors. Any devices in an industrial environment that have an appropriate communications interface and are configured to communicate using the method in accordance with disclose embodiments of the invention are possible, here. Retrofitted solutions are also possible if the communications interface is changed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described and explained in more detail below, with reference to the exemplary embodiments represented in the figures, in which:

FIG. 1 shows a schematic representation of the method in accordance with the invention;

FIG. 2 shows a network with devices for executing the method in accordance with the invention;

FIG. 3 is a flowchart of the method in accordance with the invention.

### DETAILED DESCRIPTION OF THE EXEMPLARY EMBODIMENTS

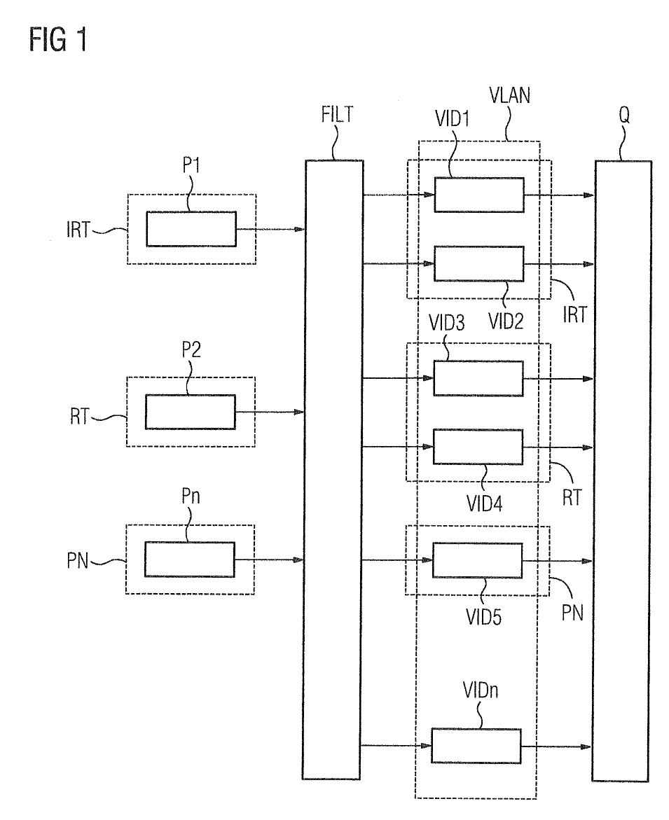

FIG. 1 shows a schematic representation of the method, as it can be applied in, for example, a switch for industrial use with an application-specific protocol, such as the PROFINET protocol. Three application-specific packets P1, P2, Pn, that are assigned respectively to classes IRT, RT and PN (isochronic class (IRT), real-time class (RT) and basic class (PN)), can be seen. The packets P1, P2, Pn can be classified in a variety of ways. It is, for example, conceivable for devices that communicate with a particular class (IRT, RT or RN) to classify their packets P1, P2, Pn directly with a corresponding identifier (also called a tag). It is possible for individual devices to communicate via a plurality of classes (IRT, RT and PN). With their ports, it is also possible for switches to perform the classification of the devices connected to them for those devices that do not have such a function. With the aid of a filter FILT the classified packets P1, P1, Pn are assigned to the virtual networks VLAN that correspond to the classes IRT, RT, PN. In addition, the filter can furthermore analyze filter identifiers FID1, . . . , FIDn (not shown here) to perform an assignment to virtual networks VLAN and assign any physical topology or resources behind them. The virtual networks VLAN each have a network identifier VID1, . . . , VIDn.

In FIG. 1, the virtual networks VLAN are provided with the network identifiers VID1 and VID2 for the isochronic class IRT. Here, it is envisaged that, for the isochronic class IRT, the virtual network VLAN with the network identifier VID1 is assigned a redundancy, which is formed here by the virtual network VLAN with the identifier VID2. Analogously, the real-time class RT also has a virtual network VLAN with the identifier VID3, as well as the redundant virtual network VLAN with the identifier VID4. The basic class PN only has one virtual network VLAN with the identifier VID5, because no redundancy is required there. In addition, a virtual network VLAN with the identifier VIDn exists that is intended to show that, in addition to the application-specific virtual networks VLAN, a standard VLAN (also: default VLAN) can also exist, and that packets that are not application-specific can also be transmitted over such a VLAN. Even packets that, while generally assignable to the application, do not have to meet any of the special requirements of the application, are possible here.

For the sake of clarity, network resource planning and resource allocation are combined in block Q, where assignment to implementation-specific resources is possible, for example based on the “tag control information” (TCI), in conjunction with a priority code point ((PCP), or user priority information). Depending on how resources are allocated, corresponding queues are then assigned to enable transmission of packets P1, P2, Pn according to their classes and to the priority, clock rate and precision (jitter) required as a result. Depending on how the queues are implemented, it is possible to provide a specific number of subqueues here. Often, 8 queue priorities are provided, although these do provide a very large number of lower level queues (subqueues).

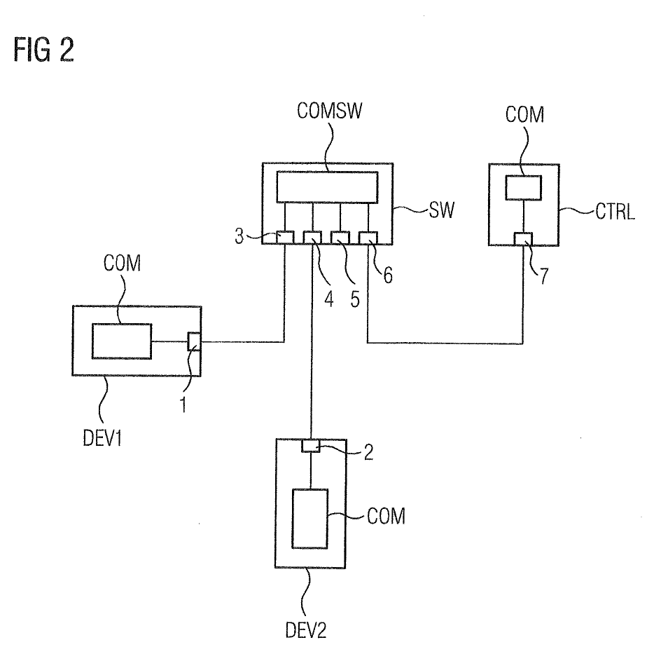

FIG. 2 shows an exemplary network in which communication in accordance with the invention can occur. Here, two terminals DEV1 and DEV2 are shown, which can communicate with each other via a switch SW. Furthermore, a controller CTRL is also connected to the switch SW. All connections are made via ports 1 to 7. These connections can, for example, be Ethernet connections, but other network connections with support from virtual networks VLAN are also possible. The two terminals DEV1 and DEV2 are in particular field devices that are actuated and/or read cyclically and with clock accuracy, for example, with an isochronic real-time class. Terminals DEV1 and DEV2 can be sensors, actuators or other industrial devices. Each of the terminals DEV1 and DEV2 has a communications interface COM for connecting the ports 1 and 2 to the ports 3 and 4 on the switch SW. At the same time, the communications interface COM can be configured such that it can classify application-specific packets and can send or receive, depending on the classification, over the selected virtual network VLAN. It is also possible that the terminal DEV2, for example, does not have this functionality. In this case, it is possible for the terminal DEV2, of which the port 2 is connected to the port 4 of the switch, nevertheless to participate in the communication, as a communications control unit COMSW of the switch SW implements the classification for the terminal DEV2.

The control device CTRL has a communications interface COM. This communications interface COM of the control device CTRL is, for example, configured such that it communicates with the two terminals DEV1 and DEV2 and makes not only controlling and regulating data, but also engineering data, available to them. The switch is, for example, configured such that its communications control unit COMSW makes the virtual networks VLAN available according to the classes IRT, RT and PN.

To summarize, the invention relates to a method of transferring application-specific packets P1, . . . , Pn in a network of an industrial automation system, where it is possible for virtual networks VLAN to be set up in the network. In order to disclose a method that efficiently enables the functions of application-specific protocols to be made available on new generations of standard hardware while retaining customary functionality, the following are implemented classification of the application-specific packets P1, . . . , and Pn into at least isochronic classes IRT, real-time classes RT and basic classes PN, provision of at least one virtual network VLAN with one network identifier VID1, . . . , VIDn per class IRT, RT, PN, and transmission of the application-specific packets P1, . . . , Pn over the virtual network VLAN selected according to its class RT, IRT, PN, together with the corresponding network identifier VID1, . . . , VIDn.

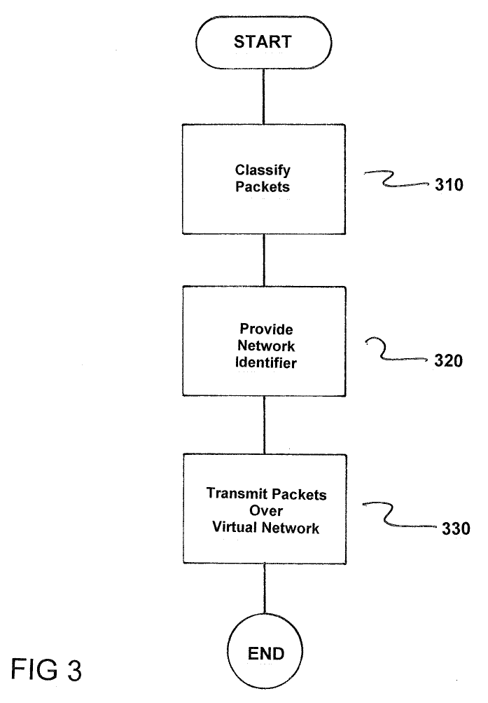

FIG. 3 is flowchart of the method for transferring application-specific packets P1, . . . , Pn in a network of an industrial automation system, where virtual networks VLAN can be set up in the network. The method comprises classifying the application-specific packets P1, . . . , Pn into at least one of (i) isochronic classes IRT, (ii) real-time classes RT and (iii) basic classes PN, as indicated in step 310.

Next, at least one virtual network VLAN is provided with a network identifier VID1, . . . , VIDn per class IRT, RT, RN, as indicated in step 320.

The application-specific packets P1, . . . , Pn is now transmitted over a virtual network VLAN selected according to a class RT, IRT, PN of the selected virtual network VLAN, together with the corresponding network identifier VID1, . . . , VIDn, as indicated in step 330.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method for transferring application-specific packets in a network of an industrial automation system, virtual networks being set up in the network, comprising:
classifying the application-specific packets into at least one of (i) isochronic classes, (ii) real-time classes and (iii) basic classes;
providing at least one virtual network with a network identifier per class; and
transmitting the application-specific packets over a virtual network selected according to a class of the selected virtual network, together with the corresponding network identifier.

2. The method as claimed in claim 1, wherein the network is Ethernet-based.

3. The method as claimed in claim 1, wherein an initialization packet is transmitted over a virtual network not assigned to any of at least one of (i) the isochronic classes and (ii) the real-time classes to initialize an application-specific connection of at least one of (i) the isochronic classes and (ii) the real-time classes.

4. The method as claimed in claim 1, wherein an initialization packet is transmitted over another virtual network to initialize an application-specific connection of at least one of (i) the isochronic classes and (ii) the real-time classes.

5. The method as claimed in claim 3, wherein another virtual network is provided for transmission of at least one of (i) the initialization packets and (ii) the application-independent packets.

6. The method as claimed in claim 3, wherein at least one filter identifier is assigned to each virtual network of the isochronic class and the real-time class.

7. The method as claimed in claim 1, wherein a redundant virtual network with a network identifier is provided for each virtual network of at least one of the class of the virtual network, (ii) an isochronic class and (iii) a real-time class.

8. The method as claimed in claim 7, wherein a filter identifier is assigned to each redundant virtual network of the isochronic class and the real-time class.

9. The method as claimed in one claim 1, wherein a higher level instance implements a configuration of the virtual network of at least one device that is using the network.

10. A communications device comprising:
at least one communications control unit; and
a plurality of ports, wherein the at least one communications control unit is configured to:
classify application-specific packets into at least one of (i) isochronic classes, (ii) real-time classes and (iii) basic classes; and
at least one of (i) send and (ii) receive application-specific packets over a virtual network; and
wherein the device is configured to:
provide at least one virtual network with a network identifier per class; and
transmit the application-specific packets over a virtual network selected according to a class of the selected virtual network, together with the corresponding network identifier.

11. The communications device as claimed in claim 10, wherein the communications device comprises one of a switch and a bridge.

12. A terminal comprising:
at least one port; and
at least one communications interface;
wherein the terminal is configured to:
classify application-specific packets in at least one of (i) isochronic classes, (ii) real-time classes and (iii) basic classes; and
at least one of (i) send application-specific packets and (ii) receive application-specific packets over a virtual network; and
wherein the terminal is configured to:
provide at least one virtual network with a network identifier per class.
